(19) United States
(12) Patent Application Publication
(10) Pub. No.: US 2005/0210735 A1
(43) Pub. Date: Sep. 29, 2005

(54) Mosquito trap

(76) Inventors: Brian Harmer, Benoni (ZA); Olivier Brian Harmer, Benoni (ZA)

Correspondence Address: BAKER & BOTTS, 30 ROCKEFELLER PLAZA, NEW YORK, NY, 10112, US

(21) Appl. No.: 10/506,154

(22) PCT Filed: Mar. 3, 2003
(86) PCT No.: PCT/IB03/00776

§ 371 Date: Apr. 11, 2005

(30) Foreign Application Priority Data
Mar. 1, 2002 (ZA) 2002/1730

(51) Int. Cl. A01M 1/10; A01M 1/02; A01M 1/04

(52) U.S. Cl. 43/107; 43/122; 43/113

(57) ABSTRACT

A trap (1) for mosquitoes and the like includes a housing (2) having an internal chamber (3) with operatively lower and upper portions (25, 26) in direct communication with each other and with entrance openings (4) in the lower portion (26) and attractant means (27) located in the lower portion (26). The attractant means include means for the generation of CO₂, a mammal body odour, a temperature in the region of 34° C. to 42° C., humidity and a stagnant water smell, and light.

### INTRODUCTION TO THE INVENTION

This invention relates to a trap for insects particularly mosquitoes and similar types of flying insects.

### BACKGROUND TO THE INVENTION

Mosquitoes or culicidae form part of the Diphera family and the hundreds of different species and sub species inhabit most parts of the earth from the tropics to the arctic.

Members of the mosquito family are well known for acting as hosts to parasites and the like which cause diseases in man such as malaria, sleeping sickness filaviasis and yellow fever. As an example of the impact of these diseases it can be noted that malaria currently accounts for more deaths than AIDS.

Mosquitoes breed in any open still or stagnant water from areas as large as swamps to those as small as water contained in old tin cans, foot prints and the like.

Research has shown that mosquitoes are attracted by:
body temperature
body smell
carbon dioxide
smell and humidity of stagnant water.

The first three of these are all prevalent in the immediate proximity of humans and other mammals making them the preferred feedings hosts for mosquitoes.

### OBJECT OF THE INVENTION

An object of the invention is to provide a trap for mosquitoes that is free of any toxic substance.

### SUMMARY OF THE INVENTION

According to the invention a trap for mosquitoes and the like includes a housing having an internal chamber; at least one entrance opening for the chamber communicating with the exterior of the housing; and attractant means within the chamber to attract mosquitoes into the housing.

Further according to the invention the chamber includes operatively lower and upper portions in direct communication with each other and with the entrance openings and attractant means located in the lower portion.

Still further according to the invention the upper portion terminates in an opening with a removable closure.

Still further according to the invention there are a plurality and preferably three or more entrance openings into the chamber.

Still further according to the invention the housing is generally cylindrical in configuration with the entrance openings spaced radially around the axis.

Still further according to the invention the upper and lower portion are co-axial.

Still further according to the invention the attractant means comprises at least one of:
first means for the generation of CO₂;
second means for the generation of a mammal body odour;
third means for the generation of a temperature in the region of 34° C. to 42° C.

Still further according to the invention the attractant means comprises at least two of the first, second and third means.

Still further according to the invention the attractant means may also include one or more of:
fourth means for the generation of humidity and a stagnant water smell;
fifth means for providing light.

Still further according to the invention the chamber includes at least one surface of a material having the characteristics similar to mammal skin.

Still further according to the invention there are a plurality of surfaces and they have a finger like configuration and are mounted in the first chamber to hang downwardly in use.

Still further according to the invention the trap may include a power supply for providing power for the means to attract mosquitoes and the power supply may include at least one battery and/or at least one solar photo voltaic cell.

### BRIEF DESCRIPTION OF THE DRAWINGS

An embodiment of the invention described by way of example only follows with reference to the accompanying drawings in which:

FIG. 1 is a front view of a mosquito trap according to the invention.

FIG. 2 is a cross sectional elevation of the trap; and

FIG. 3 is a view of a mosquito attracting device used in the trap.

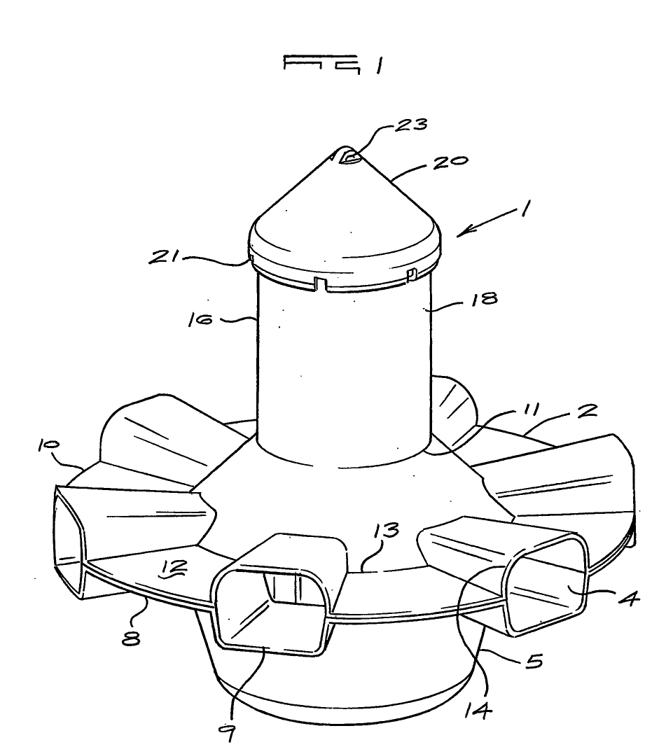

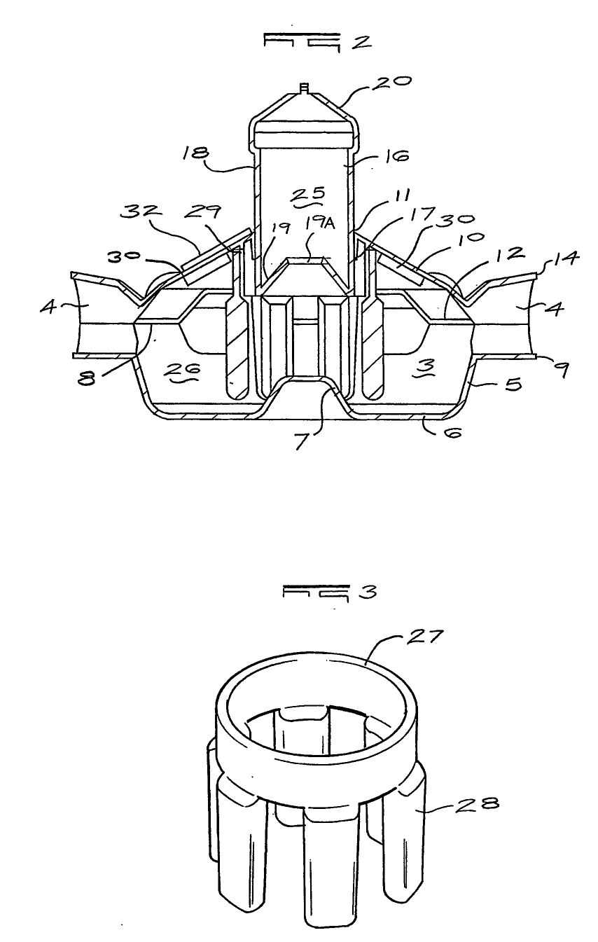

### DETAILED DESCRIPTION WITH REFERENCE TO THE DRAWINGS

In this embodiment of the invention a trap (1) for mosquitoes is made from plastics material and comprises a housing (2) which defines an internal chamber (3). This internal chamber (3) communicates with the exterior of the housing (2) by way of six radially disposed and equally spaced entrances (4).

The housing is defined by four basic components which are as follows:
a. A lower bowl shaped member (5) having a bottom surface (6) with an axially located indentation (7) therein. This lower member (5) terminates in an outwardly directed annular flange (8) having six equally spaced and radially disposed depressions (9) therein. These depressions (9) form the lower halves of the entrances (4).
b. A frusto conical middle member (10) having an axial circular opening (11) at the top thereof and an outwardly extending annular flange (12) at the base (13) thereof. This flange (12) includes six equally spaced radially disposed indentations (14) therein which form the upper portions or halves of the entrances (4) when the lower member and middle member are axially position relative to each other with their flanges abutting. In this condition the flanges may in fact be fixed with respect to each other in this abutting relationship.
c. A right circular cylindrical upper member (16) which is fixed co-axially into the opening (11) of the middle member (10) such that a lower portion (17) thereof protrudes into the area created by the middle and lower members (10) and (5) and an upper portion (18) projects upwardly therefrom. A circumferential inwardly projecting inclined flange (19) extends from the end of the lower portion (17) of the upper member (16) to provide a central aperture (19a).

d. A generally conical closure (20) for the upper member (16), the closure being removably held in place with respect to the upper end of the upper member (16) by way of engaging formations (21) of the closure (20) and the upper member (16). At its apex the closure (20) includes an orifice or eye (23) through which a string or the like may be passed to suspend the trap (1).

Within the housing (2) the chamber (3) is divided into upper and lower portions (25) and (26) with the upper portion being that defined by the upper cylindrical member (16) and the lower portion (26) being that defined by the lower and middle members (5) and (10).

Mosquito attractants as defined hereafter are placed within the lower chamber.

One of these attractants comprises a device as indicated in FIG. 3 comprising an annular member (27) from which depend (6) loosely hanging “fingers” (28). The device is made from a soft plastics material having a “mammal skin” feel to it and being impregnated with a chemical attractant which has a smell, a mammal odour such as that of human feet for example. The device (27) is located co-axially within the lower chamber (26) by way of the ring (27) fitting over a suitable annular formation (29) depending from the inner wall of the middle member (10). The fingers (28) of the device include electrical heating elements the electrical energy for which is supplied by a small battery (30) housed within the chamber and charged by way of a small solar panel (32) incorporated into the upper surface of the middle member (10). The battery will be charged during the day and will power the heating elements during the night to give a temperature of between 34° C. and 42° C.

The lower chamber may also include one or more of the following attractants:
a. means for the generation of CO₂;
b. means for the generation of a higher humidity in the surrounding atmosphere;
c. means for the generation of a stagnant water smell;
d. means for the generation of light.

Obviously the more attractant means utilised the greater will be the potential for trapping mosquitoes.

The trapping mechanism includes the mosquitoes being attracted into the lower portion (26) of the chamber by the various attractant means and settling on the skin textured fingers within the chamber. Once the mosquito's satisfaction has not been assuaged by the attractant means the mosquito again becomes airborne. The flight path of a mosquito is basically in an upwardly direction and it thus moves through the aperture (19a) into the upper portion (25) of the chamber where it remains trapped as it cannot find the aperture (19a) to fly downwardly out of the chamber. The mosquito then eventually dies.

The bodies of dead mosquitoes can be periodically removed from the trap by removal of the closure (20).

The invention thus provides a novel trap for mosquitoes.

Other embodiments of the invention are envisaged within the scope of the invention including other shapes, configurations and applications thereof.

1. A trap for mosquitoes and the like includes a housing having an internal chamber; at least one entrance opening for the chamber communicating with the exterior of the housing; and attractant means within the chamber to attract mosquitoes into the housing.

2. A trap as claimed in claim 1 in which the chamber includes operatively lower and upper portions in direct communication with each other and with the entrance openings and attractant means located in the lower portion.

3. A trap as claimed in claim 2 in which the upper portion terminates in an opening with a removable closure.

4. A trap as claimed in claim 2 in which the upper and lower portions are co-axial.

5. A trap as claimed in claim 1 in which there are a plurality of entrance openings into the chamber.

6. A trap as claimed in claim 5 in which there are at least three entrance openings.

7. A trap as claim in claim 5 in which the housing is generally cylindrical in configuration with the entrance openings spaced radially around the axis.

8. A trap as claimed in claim 1 in which the attractant means comprises at least one of:—first means for the generation of CO₂;—second means for the generation of a mammal body odour; third means for the generation of a temperature in the region of 34° C. to 42°0 C.

9. A trap as claimed in claim 8 in which the attractant means comprises at least two of the first, second and third means.

10. A trap as claimed in claim 8 in which the attractant means includes one or more of:—fourth means for the generation of humidity and a stagnant water smell;—fifth means for providing light.

11. A trap as claimed in claim 8 which includes a power supply for providing power for the means to attract mosquitoes and the power supply may include at least one battery and/or at least one solar photo voltaic cell.

12. A trap as claimed in claim 1 in which the chamber includes at least one surface of a material having the characteristics similar to mammal skin.

13. A trap as claimed in claim 12 in which there are a plurality of surfaces which have a finger like configuration and are mounted in the first chamber to hang downwardly in use.

14. A trap as claimed in claim 12 in which the surface/s are heated.

15. A trap as claimed in claim 14 which includes electrical elements for heating the surfaces.

16. (deleted)

17. A trap as claimed in claim 2 in which there are a plurality of entrance openings into the chamber.

18. A trap as claimed in claim 5 in which the attractant means comprises at least one of:—first means for the generation of CO₂;—second means for the generation of a mammal body odour; third means for the generation of a temperature in the region of 34° C. to 42° C.

19. A trap as claimed in claim 8 in which the chamber includes at least one surface of a material having the characteristics similar to mammal skin.
